(19) United States
(12) Patent Application Publication
(10) Pub. No.: US 2024/0077898 A1
(43) Pub. Date: Mar. 7, 2024

(54) SHUNT REGULATOR AND SEMICONDUCTOR DEVICE

(71) Applicant: LAPIS Technology Co., Ltd., Yokohama (JP)

(72) Inventor: Takeshi WAKAMATSU, Yokohama (JP)

(73) Assignee: LAPIS Technology Co., Ltd., Yokohama (JP)

(21) Appl. No.: 18/459,436

(22) Filed: Sep. 1, 2023

(30) Foreign Application Priority Data
Sep. 1, 2022 (JP) 2022-139197

(51) Int. Cl. G05F 1/56; G05F 1/59

(52) U.S. Cl. CPC G05F 1/562; G05F 1/59

(57) ABSTRACT

The disclosure includes a differential amplifier generating a difference voltage representing a difference between a reference voltage and a divided voltage obtained by dividing an inter-terminal voltage between a first and second terminals, a first transistor having a drain and a source connected to the first terminal and the second terminal, a voltage detection unit generating a detection voltage having a voltage value corresponding to the inter-terminal voltage, and a selection unit supplying one of the difference voltage and the detection voltage to a gate of the first transistor based on the inter-terminal voltage.

### CROSS-REFERENCE TO RELATED APPLICATION

This application claims priority under 35 USC 119 from Japanese Patent application No. 2022-139197 filed on Sep. 1, 2022, the disclosure of which is incorporated by reference herein.

### BACKGROUND

### Technical Field

The disclosure relates to a shunt regulator and a semiconductor device including the shunt regulator.

### Description of Related Art

Currently, as a two-wire transmitter capable of transmitting an information signal through a pair of transmission lines and acquiring a power supply voltage, one including a shunt regulator that maintains a voltage between the pair of transmission lines at a predetermined voltage has been proposed (see, for example, Japanese Patent Laid-Open No. 2020-102139).

The shunt regulator described in Patent Document 1 includes a differential amplifier that performs an output corresponding to a difference between a reference voltage and a voltage between two transmission lines, and a transistor that causes a current to flow between the transmission lines according to the output of the differential amplifier. In the shunt regulator, when the voltage generated between the transmission lines becomes higher than a predetermined voltage, the transistor described above enters an ON state according to the output of the differential amplifier to cause a current to flow between the transmission lines, and thereby the voltage between the transmission lines is lowered to maintain a voltage value of the transmission lines at the predetermined voltage.

Incidentally, in such a shunt regulator, when the current flowing through the transmission line increases abruptly, for example, when the current is started to be supplied to the transmission line from a state in which an amount of the current is zero, such a steep increase in current supply causes a voltage value of the transmission lines to rise sharply. At that time, in the regulator described in Patent Document 1, the voltage between the transmission lines is lowered when the differential amplifier described above operates following the rise in the voltage between the transmission lines, but a delay in output of the differential amplifier may cause a timing of lowering the voltage between the transmission lines to be delayed. As a result, a high voltage may be temporarily applied to the transistor and the differential amplifier, and both of them may be damaged.

Therefore, in order to protect the differential amplifier and the transistor described above from such a situation, it is conceivable to increase a speed of the differential amplifier by connecting a power supply stabilizing capacity to the transmission line of the shunt regulator or increasing a bias current flowing in the differential amplifier.

However, there are cases in which the power supply stabilizing capacity cannot be provided in terms of, for example, a circuit design, and a problem occurs in that an increase in the bias current flowing in the differential amplifier results in an increase in power consumption.

Therefore, the disclosure provides a shunt regulator and a semiconductor device in which damage to an internal circuit can be prevented without providing a power supply stabilizing capacity and increasing power consumption.

### SUMMARY

A shunt regulator according to an aspect of the disclosure includes a first terminal and a second terminal, a differential amplifier generating a difference voltage representing a difference between a reference voltage and a divided voltage obtained by dividing an inter-terminal voltage between the first terminal and the second terminal, a first transistor having a drain and a source connected to the first terminal and the second terminal, a voltage detection unit detecting the inter-terminal voltage to generate a detection voltage having a voltage value corresponding to the inter-terminal voltage, and a selection unit supplying one of the difference voltage and the detection voltage to a gate of the first transistor based on the inter-terminal voltage.

A semiconductor device according to another aspect of the disclosure is a semiconductor device including a shunt regulator which has a first terminal and a second terminal and adjusts an inter-terminal voltage generated between the first terminal and the second terminal to a predetermined constant voltage according to a current received by the first terminal, in which the shunt regulator includes a differential amplifier generating a difference voltage representing a difference between a reference voltage and a divided voltage obtained by dividing the inter-terminal voltage, a first transistor having a drain and a source connected to the first terminal and the second terminal, a voltage detection unit detecting the inter-terminal voltage to generate a detection voltage having a voltage value corresponding to the inter-terminal voltage, and a selection unit supplying the detection voltage to a gate of the first transistor and then supplying the difference voltage to the gate of the first transistor instead of the detection voltage when the inter-terminal voltage rises.

### BRIEF DESCRIPTION OF THE DRAWINGS

FIG. 1 is a circuit diagram showing a configuration of a shunt regulator 100.

FIG. 2 is a circuit diagram showing an example of a power-on reset circuit 110.

FIG. 3 is a time chart showing an operation of the shunt regulator 100.

FIG. 4 is a circuit diagram showing a configuration of a shunt regulator 100A.

FIG. 5 is a block diagram showing a configuration of a wireless communication system including the shunt regulator.

### DESCRIPTION OF THE EMBODIMENTS

According to the disclosure, in the shunt regulator including the differential amplifier generating a difference voltage representing a difference between a reference voltage and a divided voltage obtained by dividing an inter-terminal voltage between the cathode terminal and the anode terminal, and the first transistor having a drain and a source connected to the cathode terminal and the anode terminal, the following operations are performed when the inter-terminal voltage rises.

That is, when the inter-terminal voltage rises, first, a detection voltage having a voltage value corresponding to the inter-terminal voltage obtained by detecting the inter-terminal voltage is supplied to a gate of the first transistor, and thereby the rise in the inter-terminal voltage is suppressed. Thereafter, the operation is switched to an original operation of the shunt regulator in which the difference voltage described above is supplied to the gate of the first transistor instead of the detection voltage described above.

Thereby, damage to an internal circuit can be prevented by quickly suppressing the rise in the inter-terminal voltage without connecting a power supply stabilizing capacity to the cathode terminal or increasing a bias current flowing inside the differential amplifier.

Hereinafter, examples of the disclosure will be described in detail with reference to the drawings.

### Example 1

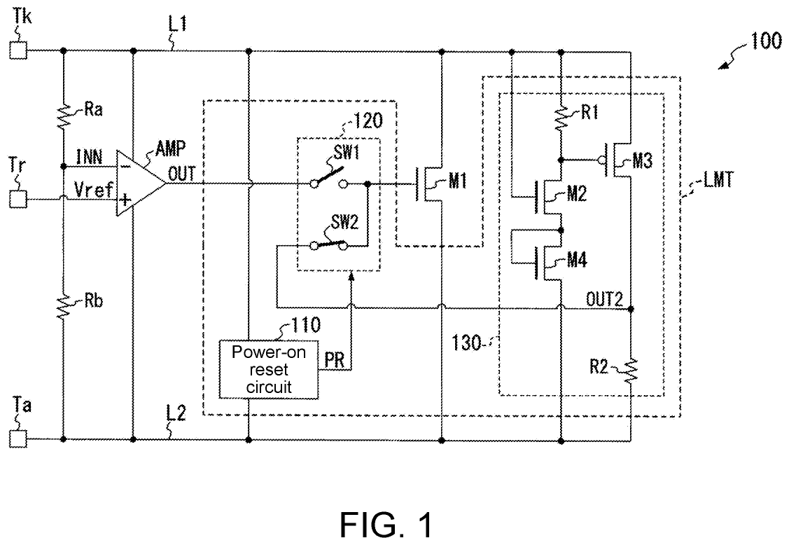

FIG. 1 is a circuit diagram showing an example of a configuration of a shunt regulator 100 according to the disclosure.

The shunt regulator 100 is formed in a semiconductor IC chip, and adjusts a voltage generated between a cathode terminal Tk and an anode terminal Ta to a constant voltage having a voltage value corresponding to a reference voltage Vref received by a reference voltage terminal Tr based on a current supplied to the cathode terminal Tk.

As shown in FIG. 1, the shunt regulator 100 includes a shunt regulator circuit unit formed of resistors Ra and Rb, a differential amplifier AMP, and an N-channel metal oxide semiconductor (MOS) type transistor M1, and a limiter circuit unit LMT.

The cathode terminal Tk and a line L1 are connected to an end of the resistor Ra, and an inverting input terminal of the differential amplifier AMP and an end of the resistor Rb are connected to the other end of the resistor Ra. The anode terminal Ta and a line L2 are connected to the other end of the resistor Rb. The resistors Ra and Rb receive a voltage between the cathode terminal Tk and the anode terminal Ta (hereinafter referred to as an inter-terminal voltage VT) via the lines L1 and L2, and generate a divided voltage INN by dividing the inter-terminal voltage VT.

The differential amplifier AMP receives the divided voltage INN by the inverting input terminal and receives the reference voltage Vref by a non-inverting input terminal. Further, the reference voltage Vref is assumed to have a voltage value smaller than that of the divided voltage INN obtained when the cathode terminal Tk receives a prescribed current. The differential amplifier AMP operates with the inter-terminal voltage VT described above as a power supply to generate a difference voltage OUT representing a difference between the divided voltage INN and the reference voltage Vref, and supplies the difference voltage OUT to the limiter circuit unit LMT.

The limiter circuit unit LMT includes a power-on reset circuit 110, a selector 120, and a voltage detection circuit 130.

The power-on reset circuit 110 receives the inter-terminal voltage VT described above via the lines L1 and L2. When the inter-terminal voltage VT rises, the power-on reset circuit 110 generates a binary (logic level 0, 1) power-on reset signal PR that, for example, maintains a state of a logic level 0 from a time point at which the inter-terminal voltage VT starts to rise until a predetermined period has elapsed and then transitions to a logic level 1 at a time point at which the predetermined period has elapsed. The power-on reset circuit 110 supplies the power-on reset signal PR to the selector 120.

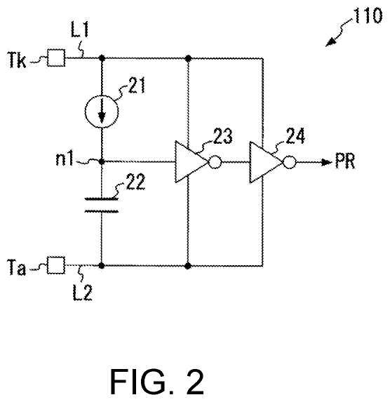

FIG. 2 is a circuit diagram showing an example of the power-on reset circuit 110.

As shown in FIG. 2, the power-on reset circuit 110 includes, for example, a current source 21, a capacitor 22, and inverters 23 and 24. The current source 21 generates a predetermined constant current according to a rise in a potential of the cathode terminal Tk, and sends it to an electrode at an end of the capacitor 22 and an input end of the inverter 23 via a node n1. The other end of the capacitor 22 is connected to the line L2. The inverters 23 and 24 operate by receiving the inter-terminal voltage VT via the lines L1 and L2. The inverter 23 has an input end thereof connected to the node n1 and an output end thereof connected to an input end of the inverter 24. The power-on reset signal PR described above is output from an output end of the inverter 24 and supplied to the selector 120.

The selector 120 includes a switch SW1 that receives the difference voltage OUT at an end, and a switch SW2 that receives a detection voltage OUT2 supplied from the voltage detection circuit 130 at an end. The other ends of the switches SW1 and SW2 are both connected to a gate of the transistor M1. The switches SW1 and SW2 are complementarily set to an ON state and an OFF state, respectively, according to the power-on reset signal PR supplied from the power-on reset circuit 110.

Thereby, when the power-on reset signal PR represents the logic level 0, the selector 120 selects the detection voltage OUT2 between the difference voltage OUT and the detection voltage OUT2 and supplies it to the gate of the transistor M1. On the other hand, when the power-on reset signal PR represents the logic level 1, the selector 120 selects the difference voltage OUT between the difference voltage OUT and the detection voltage OUT2 and supplies it to the gate of the transistor M1.

The transistor M1 has a drain thereof connected to the cathode terminal Tk via the line L1, and a source thereof connected to the anode terminal Ta via the line L2.

The voltage detection circuit 130 includes resistors R1 and R2, N-channel MOS type transistors M2 and M4, and a P-channel MOS type transistor M3.

An end of the resistor R1 is connected to the cathode terminal Tk via the line L1, and the other end thereof is connected to a drain of the transistor M2 and a gate of the transistor M3. A gate of the transistor M2 is connected to the cathode terminal Tk via the line L1, and a source thereof is connected to a drain and a gate of the transistor M4. A source of the transistor M3 is connected to the cathode terminal Tk via the line L1, and a drain thereof is connected to an end of the resistor R2. The other end of the resistor R2 and a source of the transistor M4 are connected to the anode terminal Ta via the line L2.

With such a configuration, a current flows to the resistor R1 via the transistors M2 and M4 when the inter-terminal voltage VT is equal to or larger than a voltage (hereinafter referred to as a limiter start voltage V1) determined by a threshold voltage of the transistors M2 and M4. Thereby, the transistor M3 enters an ON state, and the current flows to the resistor R2 via the transistor M3. Therefore, a voltage generated at the drain of the transistor M3 and an end of the resistor R2 by the current is supplied to the selector 120 as the detection voltage OUT2 described above. That is, the voltage detection circuit 130 performs an operation of generating the detection voltage OUT2 when the inter-terminal voltage VT is higher than a predetermined voltage (V1).

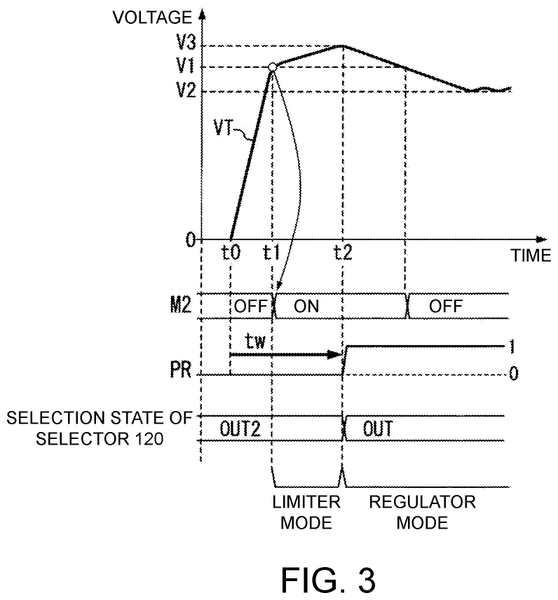

Hereinafter, an operation of the shunt regulator 100 will be described with reference to the time chart of FIG. 3.

First, an electronic device (not shown) including the shunt regulator 100 starts supply of a current to the cathode terminal Tk of the shunt regulator 100 at a time point t0 as shown in FIG. 3. Thereby, a voltage value of the inter-terminal voltage VT rises as shown in FIG. 3. When the inter-terminal voltage VT rises, the power-on reset circuit 110 generates the power-on reset signal PR that maintains a state of the logic level 0 from the time point t0 to a time point t2 at which a predetermined period tw has elapsed and maintains a state of the logic level 1 after the time point t2 as shown in FIG. 3. Therefore, the selector 120 selects the detection voltage OUT2 over the predetermined period tw shown in FIG. 3 and supplies it to the gate of the transistor M1.

Here, as shown in FIG. 3, when the voltage value of the inter-terminal voltage VT exceeds the limiter start voltage V1 at a time point t1 between the time point t0 and the time point t2, the transistor M2 enters an ON state, and a current corresponding to the inter-terminal voltage VT flows via the resistor R1. Thereby, the transistor M3 enters an ON state, and the current corresponding to the inter-terminal voltage VT flows to the resistor R2 via the transistor M3. Therefore, the detection voltage OUT2 having a voltage value corresponding to the current flowing into the resistor R2 is supplied to the gate of the transistor M1 via the selector 120. Then, the transistor M1 enters an ON state due to the detection voltage OUT2, and the current flows between the lines L1 and L2 via the transistor M1, thereby suppressing a rise in the voltage of the inter-terminal voltage VT (limiter mode).

Thereafter, as shown in FIG. 3, when the power-on reset signal PR transitions from the logic level 0 to the logic level 1 at the time point t2, the selector 120 switches to a state of selecting the difference voltage OUT instead of the detection voltage OUT2 and enters a state of supplying the difference voltage OUT to the gate of the transistor M1. Thereby, the transistor M1 enters an ON state until the inter-terminal voltage VT reaches a predetermined constant voltage V2 shown in FIG. 3, and the current flows between the lines L1 and L2 via the transistor M1, thereby lowering the inter-terminal voltage VT. Therefore, an operation after the time point t2 switches to an original operation (regulator mode) of the shunt regulator in which the inter-terminal voltage VT is lowered by controlling the transistor M1 with the difference voltage OUT representing a difference between the reference voltage Vref and the divided voltage INN obtained by dividing the inter-terminal voltage VT, and a voltage value thereof is maintained at the constant voltage V2.

As described above, in the shunt regulator 100, the power-on reset circuit 110 detects the start of supply of the current to the cathode terminal Tk. Then, according to the power-on reset signal PR serving as a power-on reset signal, first, the transistor M1 is controlled based on the voltage value (OUT2) of the inter-terminal voltage VT detected by the limiter circuit unit LMT, and thereby the rise in the voltage of the inter-terminal voltage VT is suppressed.

Thereby, the rise in the inter-terminal voltage VT at the start of supply of the current can be quickly suppressed without increasing a bias current flowing inside the differential amplifier AMP.

Therefore, according to the shunt regulator 100, damage to the differential amplifier AMP and the transistor M1 due to an increase in the inter-terminal voltage VT at the start of supply of the current can be prevented with low power consumption.

Further, in the limiter circuit unit LMT described above, in detecting the voltage value (OUT2) of the inter-terminal voltage VT, since the current does not flow until the inter-terminal voltage VT exceeds the limiter start voltage V1 which is the threshold voltage of the transistors M2 and M4, there is no current consumption during that time. Therefore, power consumption can be suppressed compared to a case of employing a circuit that constantly detects the voltage value of the inter-terminal voltage VT.

Further, in the example shown in FIG. 1, the selector 120 switches the voltage supplied to the gate of the transistor M1 due to the power-on reset signal PR generated by the power-on reset circuit 110. However, a circuit configuration thereof is not limited to the power-on reset circuit 110 and the selector 120 as long as switching of the voltages (OUT and OUT2) supplied to the gate of the transistor M1 can be performed by detecting the rise of the inter-terminal voltage VT.

Also, in the example shown in FIG. 1, the detection voltage OUT2 corresponding to the inter-terminal voltage VT has been generated by the voltage detection circuit 130, but the voltage detection circuit 130 is not limited to the circuit formed of the transistors M2 to M4 and the resistors R1 and R2 shown in FIG. 1. For example, in the voltage detection circuit 130, only one stage of the diode-connected transistor M4 has been connected in cascade as a load element between the transistor M2 and the line L2, but the number of connection stages may be two or more, and a diode, a resistor, or the like may be employed as the load element.

In short, as the shunt regulator 100, any shunt regulator including a first terminal (Tk) and a second terminal (Ta), and a differential amplifier, a first transistor, a voltage detection unit, and a selection unit described below may be used.

The differential amplifier (AMP) generates a difference voltage (OUT) representing a difference between a reference voltage (Vref) and a divided voltage (INN) obtained by dividing an inter-terminal voltage (VT) between the first and second terminals.

The voltage detection unit (130) detects the inter-terminal voltage to generate a detection voltage (OUT2) having a voltage value corresponding to the inter-terminal voltage. When the inter-terminal voltage rises, the selection unit (120) supplies the detection voltage (OUT2) to a gate of a first transistor (M1) having a drain and a source connected to the first terminal and the second terminal, and then supplies the difference voltage (OUT) to a gate of the first transistor instead of the detection voltage.

### Example 2

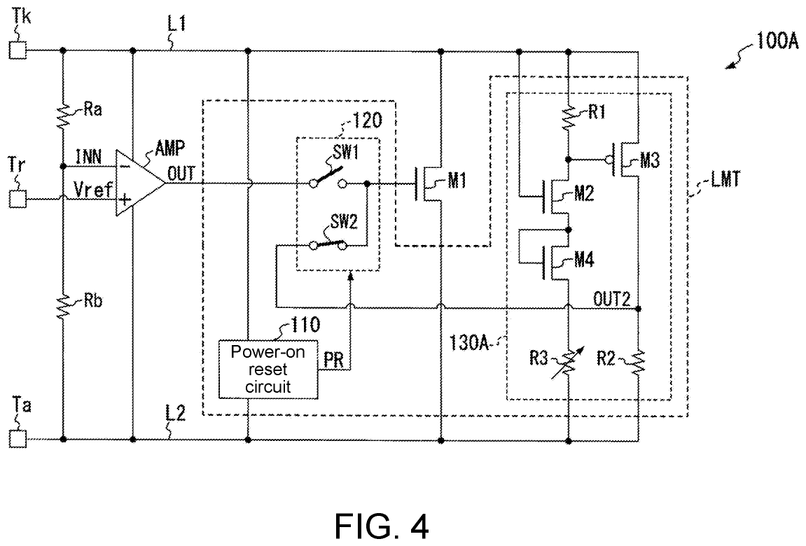

FIG. 4 is a circuit diagram showing a configuration of a shunt regulator 100A that has a function of adjusting a voltage value of the limiter start voltage V1 shown in FIG. 3 in the shunt regulator 100 shown in FIG. 1.

Further, other configuration of the shunt regulator 100A are the same as those of the shunt regulator 100 except that a voltage detection circuit 130A is employed instead of the voltage detection circuit 130. Also, other configurations of the voltage detection circuit 130A are the same as those of the voltage detection circuit 130 except that a variable resistor R3 is newly provided between the source of the transistor M4 and the line L2. Therefore, only an operation performed by the variable resistor R3 will be described below.

In the limiter circuit unit LMT, it is configured such that a voltage for starting an operation of suppressing the rise of the inter-terminal voltage VT, that is, the limiter start voltage V1, immediately after the start of supply of the current can be adjusted by the variable resistor R3. That is, the limiter start voltage V1 shown in FIG. 3 decreases as a resister value of the variable resistor R3 becomes lower, the limiter mode correspondingly is started earlier, and a voltage value V3 of the inter-terminal voltage VT at the transition time point t2 from the limiter mode to the regulator mode becomes lower.

### Example 3

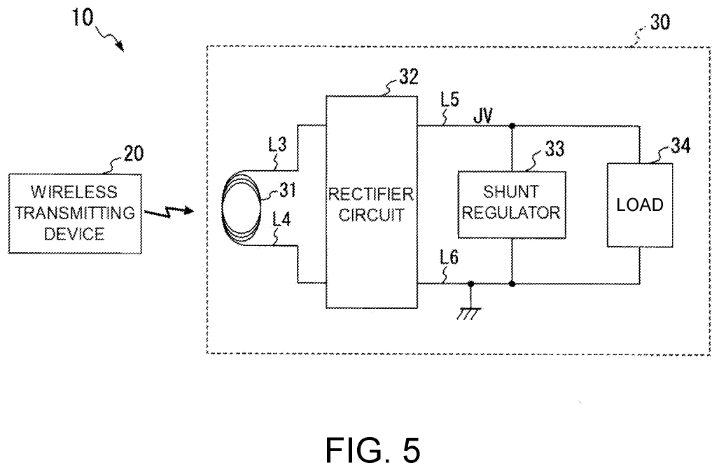

FIG. 5 is a block diagram showing a configuration of a wireless communication system as an example of an electronic device including the shunt regulator 100 or 100A described above.

As shown in FIG. 5, the wireless communication system 10 includes a wireless transmitting device 20 and a wireless receiving device 30.

The wireless transmitting device 20 transmits radio waves for wireless power supply or information communication.

The wireless receiving device 30 includes an antenna 31 for receiving the radio waves, a rectifier circuit 32, a shunt regulator 33, and a load 34.

The antenna 31 applies an AC voltage having a voltage value corresponding to the received radio waves to lines L3 and L4. The rectifier circuit 32 sends a DC current obtained by, for example, full-wave rectifying the AC voltage of the lines L3 and L4 to a line L5. The shunt regulator 33 has the circuit configuration shown in FIG. 1 or 4 connected to the lines L5 and L6. That is, the cathode terminal Tk of the shunt regulator 33 is connected to the line L5, and the anode terminal Ta thereof is connected to the line L6. Thereby, the shunt regulator 33 adjusts an inter-terminal voltage JV generated on the lines L5 and L6 to the predetermined constant voltage V2 as shown in FIG. 3 according to the current sent to the line L5. The load 34 is, for example, a battery and is charged by the constant voltage V2.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A shunt regulator comprising:
a first terminal and a second terminal;
a differential amplifier generating a difference voltage representing a difference between a reference voltage and a divided voltage obtained by dividing an inter-terminal voltage between the first terminal and the second terminal;
a first transistor having a drain and a source respectively connected to the first terminal and the second terminal;
a voltage detection unit detecting the inter-terminal voltage to generate a detection voltage having a voltage value corresponding to the inter-terminal voltage; and
a selection unit supplying one of the difference voltage and the detection voltage to a gate of the first transistor based on the inter-terminal voltage.

2. The shunt regulator according to claim 1, wherein when the inter-terminal voltage rises, the selection unit supplies the detection voltage to the gate of the first transistor and then supplies the difference voltage to the gate of the first transistor instead of the detection voltage.

3. The shunt regulator according to claim 1, wherein the voltage detection unit performs an operation of generating the detection voltage when the inter-terminal voltage is higher than a predetermined first voltage.

4. The shunt regulator according to claim 3, wherein the voltage detection unit includes:
a first resistor having an end connected to the first terminal;
a second transistor having a drain connected to an other end of the first resistor and having a gate connected to the first terminal;
a load element having an end connected to a source of the second transistor and an other end connected to the second terminal;
a third transistor having a source connected to the first terminal and a gate connected to an other end of the first resistor; and
a second resistor having an end connected to a drain of the third transistor and an other end connected to the second terminal.

5. The shunt regulator according to claim 4, wherein the load element includes a fourth transistor having a drain and a gate connected to the source of the second transistor and a source connected to the second terminal.

6. The shunt regulator according to claim 4, wherein the load element includes:
a fourth transistor having a drain and a gate connected to the source of the second transistor; and
a variable resistor having an end connected to a source of the fourth transistor and an other end connected to the second terminal.

7. The shunt regulator according to claim 2, wherein the voltage detection unit performs an operation of generating the detection voltage when the inter-terminal voltage is higher than a predetermined first voltage.

8. The shunt regulator according to claim 7, wherein the voltage detection unit includes:
a first resistor having an end connected to the first terminal;
a second transistor having a drain connected to an other end of the first resistor and having a gate connected to the first terminal;
a load element having an end connected to a source of the second transistor and an other end connected to the second terminal;
a third transistor having a source connected to the first terminal and a gate connected to an other end of the first resistor; and
a second resistor having an end connected to a drain of the third transistor and an other end connected to the second terminal.

9. The shunt regulator according to claim 8, wherein the load element includes a fourth transistor having a drain and a gate connected to the source of the second transistor and a source connected to the second terminal.

10. The shunt regulator according to claim 8, wherein the load element includes:
a fourth transistor having a drain and a gate connected to the source of the second transistor; and
a variable resistor having an end connected to a source of the fourth transistor and an other end connected to the second terminal.

11. The shunt regulator according to claim 1, wherein the selection unit includes:
a power-on reset circuit generating a power-on reset signal having, when the inter-terminal voltage rises, a first level from a time point at which the inter-terminal voltage starts to rise until a time point at which a predetermined period has elapsed and having a second level after the time point of the time at which the predetermined period has elapsed; and
a selector supplying the detection voltage to the gate of the first transistor when the power-on reset signal is at the first level and supplying the difference voltage to the gate of the first transistor when the power-on reset signal is at the second level.

12. The shunt regulator according to claim 2, wherein the selection unit includes:
a power-on reset circuit generating a power-on reset signal having, when the inter-terminal voltage rises, a first level from a time point at which the inter-terminal voltage starts to rise until a time point at which a predetermined period has elapsed and having a second level after the time point of the time at which the predetermined period has elapsed; and
a selector supplying the detection voltage to the gate of the first transistor when the power-on reset signal is at the first level and supplying the difference voltage to the gate of the first transistor when the power-on reset signal is at the second level.

13. A semiconductor device, which is a semiconductor device including a shunt regulator which has a first terminal and a second terminal and adjusts an inter-terminal voltage generated between the first terminal and the second terminal to a predetermined constant voltage according to a current received by the first terminal, wherein the shunt regulator includes:
a differential amplifier generating a difference voltage representing a difference between a reference voltage and a divided voltage obtained by dividing the inter-terminal voltage;
a first transistor having a drain and a source respectively connected to the first terminal and the second terminal;
a voltage detection unit detecting the inter-terminal voltage to generate a detection voltage having a voltage value corresponding to the inter-terminal voltage; and
a selection unit which, when the inter-terminal voltage rises, supplies the detection voltage to a gate of the first transistor and then supplies the difference voltage to the gate of the first transistor instead of the detection voltage.
